(19) United States
(12) Patent Application Publication
(10) Pub. No.: US 2005/0267805 A1
(43) Pub. Date: Dec. 1, 2005

(54) Internet based method for reserving and purchasing advertising time in the electronic media

(76) Inventor: Franklin J.A. Tarantino, Mount Arlington, NJ (US)

Correspondence Address: RICHARD L. BIGELOW, 203 TREMONT STREET, NEWINGTON, CT, 06111, US

(21) Appl. No.: 11/133,881

(22) Filed: May 21, 2005

Related U.S. Application Data
(60) Provisional application No. 60/574,199, filed on May 25, 2004.

(51) Int. Cl. G06F 17/60

(52) U.S. Cl. 705/14

(57) ABSTRACT

This invention relates to an Internet-based System and method for scheduling and purchasing advertising time and inserting advertising messages into the digital media. The invention utilizes the Advertising Time Selection and Purchasing Module to determine the availability and price of advertising time in certain electronic media and transmit this information to the Advertiser. The Advertiser then makes the decision to purchase the time and inserts his or her message into the electronic media. The System then bills the Advertiser for the selected time.

### CROSS REFERENCE TO RELATED APPLICATIONS

This non-provisional patent application claims priority based on provisional patent application 60/574,199 dated May 25, 2004.

### FEDERAL RESEARCH STATEMENT

None

### BACKGROUND OF THE INVENTION

1. Field of the Invention

This invention relates to an Internet-based System and Method for scheduling and purchasing advertising time, space and production for distribution into electronic media. Scheduling and purchasing of messages in the electronic media is a well known and mature process. This invention presents a significant enhancement and evolution of this established process, making it more widely available to potential advertisers, more seamless, more user-friendly, and faster. In addition, the system provides more control over which messages go to which venues. Consequently the invention offers much quicker and even instantaneous and consistent control over the availability and sale of messages (production, advertising space and time) to a wider universe of advertisers.

More specifically, the invention provides for an Internet based method for multiple advertisers to quickly and easily purchase advertisement production, advertisement air-time or advertisement space made available by owners and operators of various media. Said advertisers can use the invention to: select desired media, select venues, submit/edit/review specific content, assign message duration and frequency, and obtain a price and pay for their message campaign.

This application is written using, as an example of the invention, the case of announcements played on audio systems within retail stores. However, the invention has application for other media such as newsprint, magazines, video, radio, television, Internet, etc.

2. Description of the Related Art

Existing Processes

There are existing systems and methods to purchase and schedule advertising space and production. However, known and established processes are labor-intensive and inherently slow. They utilize a sales effort involving intensive human intervention, and extensive back-office support infrastructures. For example, a media sales executive calls on potential or established advertisers. The advertiser who chooses to make a purchase of air-time informs the sales executive of the desired message content, days or day-parts for the advertisement to run, and frequency of the message (such as every 60 minutes). Furthermore, typically the precise venue and specific audience of the message delivery media is established de facto. For example, advertisers choosing to advertise on Radio Station XYZ, have essentially pre-determined what is commonly known in the advertising industry as “reach” because Radio Station XYZ has a known and finite audience size (or reach) based on the station's broadcast wattage and established listener demographics. Note: It will be demonstrated later in this application how, among other advantages, the invention provides for more effective control over audience reach.

Once the information described above (and other information as required by specific station operators) is collected by the sales executive, it is entered some period of time later by either the sales executive or his/her designee into what is commonly referred to in the radio business as a traffic and billing system. Traffic and billing systems are used by radio stations to manage their sales and billing of air-time sold to advertisers. These systems can be quite complex, require extensive training, and users generally need to have a working knowledge of industry jargon to use these systems effectively.

Advent of Internet-based Business Process Opportunities

The development of the Internet is creating an environment allowing system and business process designers to develop creative new and expeditious ways to accomplish important business tasks. The Internet is an evolving system serving, among other benefits, to facilitate the sharing and transfer of information. Furthermore, Internet access has become ubiquitous. Pioneering web sites have provided, for example, for the sale of goods and the sharing of information (e.g. book sales, medical encyclopedia web sites).

### SUMMARY OF THE INVENTION

It is an object of the invention to provide a method whereby an advertiser can schedule and purchase advertising space and production in the electronic media with a user-friendly, flexible, web-based method.

It is another object of the invention to provide a method that enables a plurality of advertisers to access the system to accomplish the task of purchasing message air-time and production.

It is another object of the invention to enable this plurality of advertisers to select and purchase advertising time on a specific retailer's in-store audio system. These advertisers are pre-approved by the retailer.

It is another object of the invention to allow retailers to review, suggest updates to, and approve content submitted by the plurality of advertisers.

It is another object of the invention to enable the media operator or owner to add/edit/delete specific message venues.

It is another object of the invention to provide internal control parameters—based on retailer-established ad frequency limiting policies—thus eliminating an over-sold condition for air-time or ad space.

Instead of enduring the labor-intensive, time consuming, and inefficient process of purchasing and scheduling advertising time by contacting and engaging in repeated interaction with a sales person, an advertiser can log into a web site, determine the availability of advertising space, set ad frequency and venue, submit content, obtain a price, place his or her request to purchase, and purchase her or his campaign.

The Advertising Air Time Purchasing System described in this application gives the advertiser the ability to create his or her advertising campaigns, edit or change a current campaign, as well as other related functions.

When adding a campaign, the advertiser establishes the following parameters: announcement content, dates, venues, frequencies and others as may be required to completely define the campaign. As mentioned above, because the advertiser can select specific venues, she or he has increased control over message “reach.”

After the retailer approves announcement content, the invention allows an advertiser to pay for his/her advertising campaign in a few short minutes using the Internet. The invention represents a tremendous increase in productivity for advertising and marketing groups in all types of organizations.

### BRIEF DESCRIPTION OF DRAWINGS

FIG. 1 is a schematic of an overview of the invention and the process flows inherent in the instant invention.

FIG. 2 is a block diagram of an overview of the process.

### DETAILED DESCRIPTION OF THE INVENTION

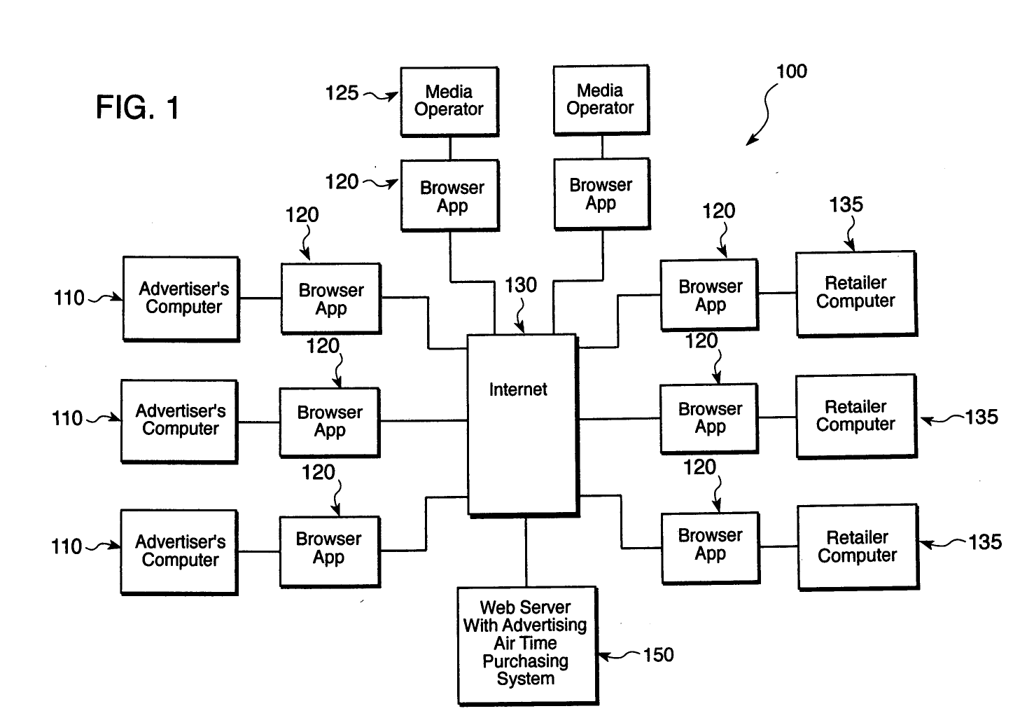

A preferred embodiment of the computer architecture of the invention is illustrated in FIG. 1.

Referring to FIG. 1, the Invention 100 includes computers used by three groups (Advertisers 110, Media Operators 125, and Retailers 135) utilizing browser applications 120 (e.g. Internet Explorer, Netscape. etc.) that support HTTP and other web protocols. The invention also involves a System 150 designed to enable Advertisers 110 to procure advertising production and air-time for use on the retailer's in-store audio system. The invention is not restrictive of who happens to operate the Retailer's In-store audio system. The retailer's in-store audio system may, in fact, be operated by a third party, a Media Operator. Consequently, the Media Operator's computer 125 is a vital component of the invention. Computers involved in the invention (110, 125, and 135) are typically connected to the Internet 130 via an Internet Service Provider (ISP) and may utilize conventional dial-up, or broadband connections such as a Digital Subscriber Line (DSL), cable modem, wireless, or network connection. The Advertising Air Time Purchasing System 150 resides on a web server accessing the Internet from a Host computer and provides the enabling intelligence to achieve the desired objectives of the invention.

The Advertising Air Time Purchasing System 150 allows the Advertiser to determine the availability of air-time, purchase air time, submit a script, obtain review from the Retailer or Media Operator, re-submit revised scripts, gain approval after (potentially) multiple iterations of script development, pay for the campaign, and listen to audio files of their announcement. These audio files could potentially be produced by the Media Operator, the Retailer or another third party. Alternately, these files can be submitted by the Advertiser.

The above description demonstrates that the Advertising Air Time Purchasing System is a wholly integrated system allowing Advertisers, Media Operators, and Retailers to interact electronically, seamlessly, and rapidly enabling advertisers to purchase air time and advertisement production for use in retailers' venues.

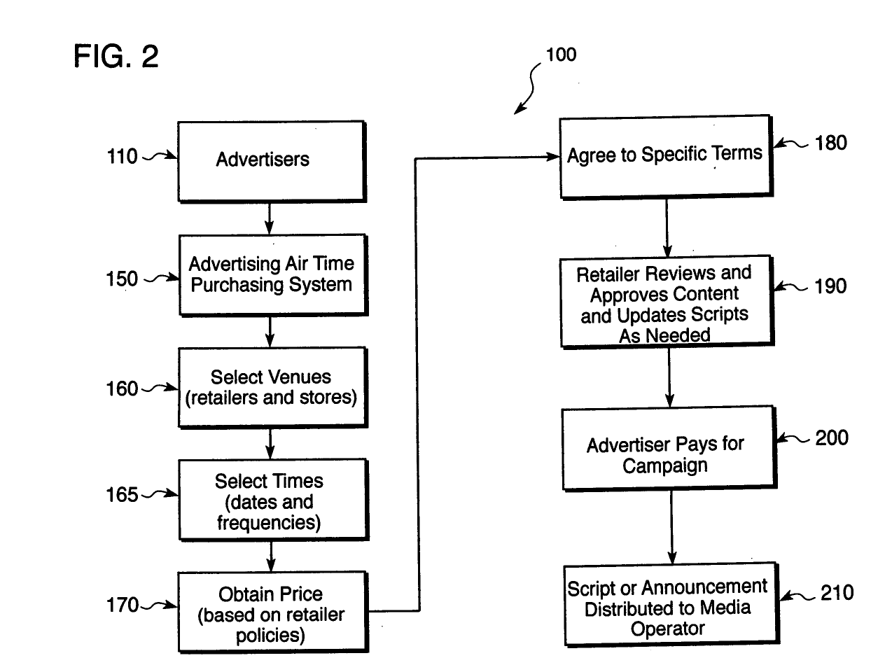

A preferred embodiment of the process flow of the invention is illustrated in FIG. 2.

Referring to FIG. 2, an Advertiser using a computer 110 can utilize the Advertising Air Time Purchasing System 150 to determine the availability and price of advertising time for given Advertising Venues.

The Advertiser selects specific venues 160 within which he or she would like the announcements to run. She or he then selects available Times 165 (dates and frequencies) that he or she would like the advertisements to run based on availability of said Times. The System 150 responds to the Advertiser with pricing 170 based upon the Advertiser's specific request and on the Retailer's specific pricing policies. The System then requires that the Advertiser agree to the Retailer's terms and conditions 180 for airing the advertisements. This is important because the retailer is responsible for the shopper's experience, it is critical for the Retailer to maintain total control over the content delivered on their in-store audio system.

The System then requires that the Retailer review the content of the advertisement and, if required, suggest updates to the content of the advertisements 190. After potentially several iterations of script updates, the Retailer grants final approval to the script (and campaign which is described by the venues, dates, frequencies, script, etc). Note that the Retailer does not have to accept the campaign. The Retailer can totally and completely reject the campaign and any part thereof. The System then invoices the Advertiser, who makes payment 200. Upon completion of all the preceding steps, the Advertising Script or fully produced Announcement (e.g. audio file) is distributed to the Media Operator 210, Retailer or third party using the System 150. The announcement is then aired on the Media Operator's system in selected Retailer venues. The invention operates independently of whatever delivery method or system is used by the Retailer to provide in-store audio, satellite or Internet-based air time.

1. A system and method of scheduling and purchasing advertising time, space and production for distribution in the electronic, print, or other media comprising the following:
a web server containing the Advertising Air Time Purchasing system;
at least one advertiser's computer;
a web browser application residing on each advertiser's computer,
at least one media operator's computer;
a web browser application residing on each media operator's computer;
at least one retailer's computer; and
a web browser application residing on each retailer's computer.

2. The system and method described in claim 1 wherein the Advertiser can select the venue in which he would like to advertise.

3. The system and method described in claim 1 wherein the Advertiser can determine the availability of advertising time for given advertising venues.

4. The system and method described in claim 1 wherein the Advertiser can determine the price for advertising time for given advertising venues.

5. The system and method described in claims 1, 2, 3, and 4 wherein the Advertiser can select the venue, time, frequency, and price for running advertisements and reserve and schedule same.

6. A system and method described in claim 1 wherein the advertisements are pre-approved by the retailer.

7. A system and method as described in claim 1 wherein the retailer has the ability to reject the purchase and scheduling of advertising time by an Advertiser.

8. A system and method as described in claim 1 wherein more than one advertiser, more than one Media Operator, and more than one Retailer can interact simultaneously to schedule and purchase advertising time, space and production.

9. A system and method as described in claim 1 wherein all the interactions are conducted over the internet.

10. A system and method as described in claim 1 wherein Advertisers and Media Operators connect directly with Retailer's computer in order to enhance security in order to schedule and purchase advertising time.

11. An Advertising Air Time Purchasing architecture that determines advertising air time availability for select dates and times at select venues.

12. An Advertising Air Time Purchasing software module as in claim 11 that obtains a price.

13. An Advertising Air Time Purchasing software module as in claim 11 that allows the retailer and advertiser to agree to terms of the advertising campaign.

14. An Advertising Air Time Purchasing software module as in claim 11 that obtains a price based on retailer policies.

15. An Advertising Air Time Purchasing software module as in claim 11 that allows multiple Advertisers, Media Operators, and Retailers to obtain a price, agree to terms of the advertising campaign, and meet retailer policies.
